(19) United States
(12) Patent Application Publication
(10) Pub. No.: US 2026/0281290 A1
(43) Pub. Date: Sep. 17, 2026

(54) PROJECTION DISPLAY DEVICE AND WHITE BALANCE ADJUSTMENT METHOD

(71) Applicant: HISENSE LASER DISPLAY CO., LTD., Qingdao (CN)

(72) Inventors: Xu CHEN, Qingdao (CN); Chao WU, Qingdao (CN)

(73) Assignee: HISENSE LASER DISPLAY CO., LTD., Qingdao (CN)

(21) Appl. No.: 19/682,429

(22) Filed: May 20, 2026

Related U.S. Application Data
(63) Continuation of application No. PCT/CN2024/132487, filed on Nov. 15, 2024.

(30) Foreign Application Priority Data
Nov. 20, 2023 (CN) 202311553434.X
Feb. 18, 2024 (CN) 202410182350.8

(51) Int. Cl. H04N 9/31

(52) U.S. Cl. CPC H04N 9/3182; H04N 9/312; H04N 9/3164; H04N 9/3191

(57) ABSTRACT

Disclosed are a projection display device and a white balance adjustment method. The projection display device includes a processor configured for: driving a primary color light source to emit primary color light, and obtaining a first color coordinate value of white light generated by mixing the primary color light; and when deviation between the first color coordinate value and a standard color coordinate value is greater than a deviation threshold value, adjusting light emission parameters of the primary color light source based on the standard color coordinate value, so that deviation between a color coordinate value of white light generated by mixing primary color light emitted by the adjusted primary color light source and the standard color coordinate value is less than or equal to the deviation threshold value, where the standard color coordinate value is a white light color coordinate that the projection display device is expected to achieve.

### CROSS-REFERENCE TO RELATED APPLICATIONS

This application is a continuation application of International Patent Application of PCT application serial No. PCT/CN2024/132487 filed on Nov. 15, 2024, which claims priority to Chinese Patent Application No. 202311553434.X filed on Nov. 20, 2023 and entitled “WHITE BALANCE ADJUSTMENT METHOD AND APPARATUS, LASER PROJECTION DEVICE, AND STORAGE MEDIUM”, and Chinese Patent Application No. 202410182350.8 filed on Feb. 18, 2024 and entitled “PROJECTION DISPLAY DEVICE, WHITE BALANCE ADJUSTMENT METHOD, AND WHITE BALANCE ADJUSTMENT SYSTEM”, the entire contents of which are incorporated herein by reference.

### TECHNICAL FIELD

The present application relates to the technical field of projection, and in particular, to a projection display device and a white balance adjustment method.

### BACKGROUND

White balance of a projection display device is an important metric for describing accuracy of white light generated by mixing three primary colors (red, green, and blue) in a display thereof, which determines whether the projection display device can accurately reproduce original colors. However, the white balance of the projection display device is easily affected by light source conditions such as a light source, an optical path, and luminous efficacy, leading to color cast during image display and resulting in imbalance of white balance. Therefore, during manufacturing and subsequent usage of the projection display device, white balance adjustment is required for the projection display device to ensure that the projection display device can accurately display colors.

### SUMMARY

In a first aspect, a projection display device is provided, the projection display device including:
a primary color light source configured to emit primary color light;
a digital micromirror device (DMD) located on a light exit side of the primary color light source and configured to modulate the primary color light and reflect the modulated light to a projection lens;
the projection lens configured to project a light beam exiting from the DMD; and
a processor connected to the primary color light source and configured to:
   drive the primary color light source to emit primary color light, and obtain a first color coordinate value of white light generated by mixing the primary color light; and
   when deviation between the first color coordinate value and a standard color coordinate value is greater than a deviation threshold value, adjust a light emission parameter of the primary color light source based on the standard color coordinate value, so that deviation between a color coordinate value of white light generated by mixing primary color light emitted by the adjusted primary color light source and the standard color coordinate value is less than or equal to the deviation threshold value, wherein the standard color coordinate value is a white light color coordinate that the projection display device is expected to achieve.

In a second aspect, a white balance adjustment method applied to a projection display device is provided, the method including:
driving a primary color light source to emit primary color light, and obtaining a first color coordinate value of white light generated by mixing the primary color light; and
adjusting a light emission parameter of the primary color light source based on the standard color coordinate value when deviation between the first color coordinate value and a standard color coordinate value is greater than a deviation threshold value, so that deviation between a color coordinate value of white light generated by mixing primary color light emitted by the adjusted primary color light source and the standard color coordinate value is less than or equal to the deviation threshold value, where the standard color coordinate value is a white light color coordinate that the projection display device is expected to achieve.

In a third aspect, a white balance adjustment system is provided, and the system includes: a main control device, an illuminometer, and the projection display device described in the first aspect, the main control device being connected to the projection display device and the illuminometer respectively; and
the main control device being configured to control the projection display device to enter a white balance calibration mode, so that the projection display devices project a plurality of test images in chronological order; and control the illuminometer to collect color coordinate values corresponding to the test images, determine, according to a white balance algorithm and the color coordinate values, target current duty cycles corresponding to a plurality of primary colors constituting pixel colors, and send the target current duty cycles to the projection display device.

In a fourth aspect, a non-transitory computer-readable storage medium is provided, the non-transitory computer-readable storage medium storing at least one instruction, at least one program, a code set or an instruction set, the at least one instruction, the at least one program, the code set, or the instruction set being loaded or executed by a processor to implement the white balance adjustment method provided in the second aspect.

In a fifth aspect, a computer program product is provided, the computer program product including a program instruction, when the program instruction is executed by a processor, the white balance adjustment method provided in the second aspect being implemented.

### BRIEF DESCRIPTION OF THE DRAWINGS

In order to more clearly illustrate the technical solutions in embodiments of the present application, the accompanying drawings used in the description of the embodiments will be briefly introduced below. It is apparent that the accompanying drawings in the following description are only some embodiments of the present application, and other drawings can be obtained by those of ordinary skill in the art from the provided drawings without creative efforts.

FIG. 1 is a schematic structural diagram of a projection display device according to embodiments of the present application;

FIG. 2 is a block diagram of hardware configuration in a projection display device according to embodiments of the present application;

FIG. 3 is a schematic diagram of an internal structure of a laser projection device according to embodiments of the present application;

FIG. 4 is a schematic diagram of software configuration in a projection display device according to embodiments of the present application;

FIG. 5 is a schematic diagram of an application scenario according to embodiments of the present application;

FIG. 6 is a schematic diagram of an optical path architecture of a laser projection device according to embodiments of the present application;

FIG. 7 is a schematic diagram of color coordinate values according to embodiments of the present application;

FIG. 8 is a schematic structural diagram of a phosphor wheel according to embodiments of the present application;

FIG. 9 is a schematic diagram of a color gamut chart according to embodiments of the present application;

FIG. 10 is a schematic structural diagram of another projection display device according to embodiments of the present application;

FIG. 11 is a schematic flowchart of a white balance adjustment method according to embodiments of the present application;

FIG. 12 is a schematic architectural diagram of a white balance adjustment system according to embodiments of the present application;

FIG. 13 is a schematic structural diagram of hardware of a main control device and a projection display device according to embodiments of the present application;

FIG. 14 is a schematic flowchart of another white balance adjustment method according to embodiments of the present application;

FIG. 15 is a schematic flowchart of yet another white balance adjustment method according to embodiments of the present application; and

FIG. 16 is a schematic structural diagram of a white balance adjustment apparatus according to embodiments of the present application.

### DETAILED DESCRIPTION

To make the objectives and implementation methods of the present application clearer, exemplary implementations of the present application will be clearly and completely described below with reference to the accompanying drawings in exemplary embodiments of the present application. Obviously, the described exemplary embodiments are merely some embodiments rather than all embodiments of the present application.

It should be noted that brief descriptions of terms in the present application are only for the purpose of facilitating the understanding of the implementations described below, and are not intended to limit the implementations of the present application. Unless otherwise stated, these terms should be understood in ordinary and common meanings thereof.

The terms “first,” “second,” “third,” and the like used in the specification, claims, and drawings of the present application are used to distinguish similar or identical objects or entities, and do not necessarily imply a specific order or sequence, unless otherwise specified. It should be understood that such terms may be used interchangeably in appropriate situations.

The terms “comprise/include” and “have” and any variations thereof are intended to cover but not exclude inclusion. For example, a product or device that includes a series of components is not necessarily limited to including all components explicitly listed, but may include other components not explicitly listed or inherent to such products or devices.

Before introduction to the white balance adjustment method provided in embodiments of the present application, a projection display device, an application background, and an implementation environment to which the technical solutions of the embodiments of the present application are applicable are introduced first.

First, a structure of the projection display device to which the technical solutions of the embodiments of the present application are applicable is introduced.

The projection display device provided in implementations of the present application may be implemented in various forms, such as a projection device, a laser projection device, a television, a display, a laser television, and the like.

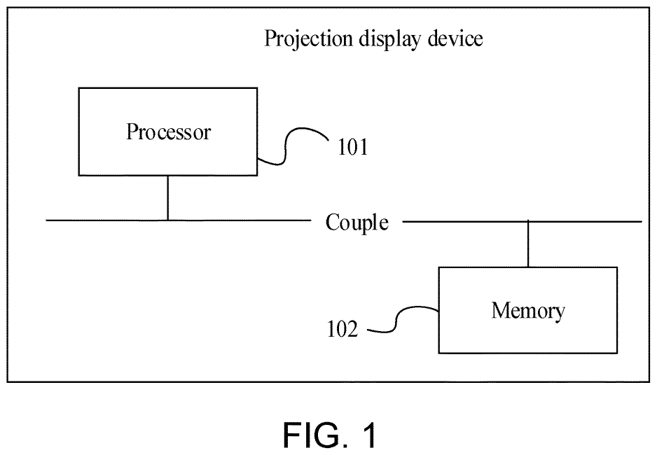

In some embodiments, FIG. 1 is a schematic structural diagram of a projection display device according to embodiments of the present application. As shown in FIG. 1, the projection display device includes a processor 101, a memory 102, and a computer program stored in the memory 102 and executable by the processor 101. When the computer program is executed by the processor 101, the white balance adjustment method according to the embodiments of the present application is implemented.

The processor 101 may be a Central Processing Unit (CPU), or may be a general-purpose processor, a Digital Signal Processor (DSP), an Application Specific Integrated Circuit (ASIC), or the like. The general-purpose processor may be a microprocessor, or the processor may be any conventional processor or the like.

The memory 102 may include a high-speed Random Access Memory (RAM), a Read-Only Memory (ROM), or a Non-Volatile Memory (NVM), such as at least one disk memory.

In some embodiments, the projection display device further includes a bus (not shown in the figure), and the processor 101 and the memory 102 may be connected via the bus.

The bus may be an Industry Standard Architecture (ISA) bus, a Peripheral Component Interconnect (PCI) bus, an Extended Industry Standard Architecture (EISA) bus, or the like. For example, the bus may include an address bus, a data bus, a control bus, or the like. It should be understood that the bus is not limited to including only one bus or only one type of bus.

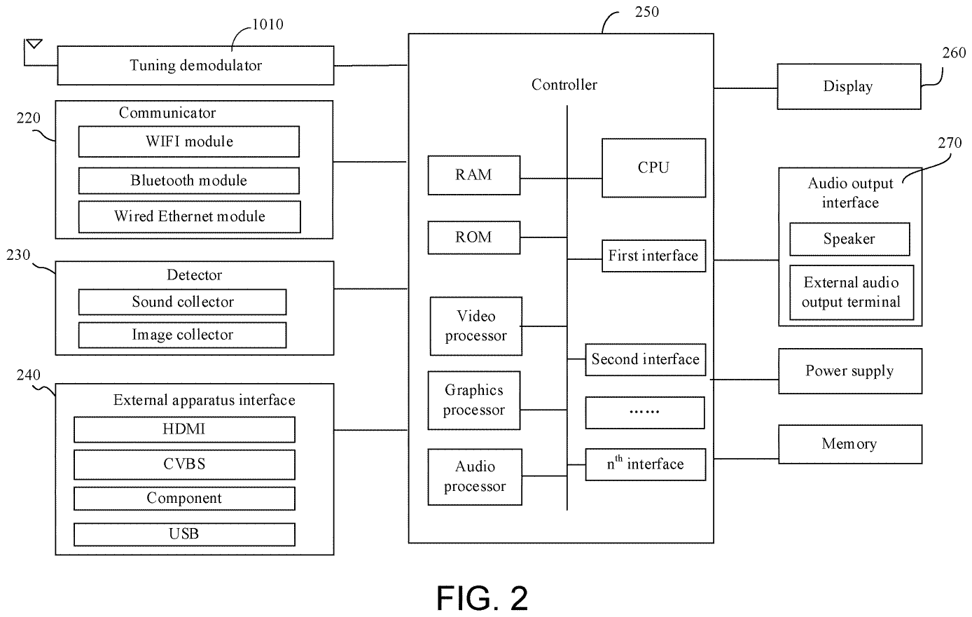

In some embodiments, FIG. 2 is a block diagram of hardware configuration in a projection display device according to embodiments of the present application. The projection display device includes: a tuning demodulator 210, a communicator 220, a detector 230, an external apparatus interface 240, a controller 250, a display 260, an audio output interface 270, a memory, a power supply, and the like.

The tuning demodulator 210 receives broadcast television signals in a wired or wireless manner, and demodulates audio and video signals, such as Electronic Program Guide (EPG) data signals, from a plurality of wireless or wired broadcast television signals. The detector 230 is configured to collect signals from an external environment or signals for interacting with the outside, and may include an audio collector and an image collector. The controller 250 includes a CPU, a video processor, an audio processor, a graphics processor, a RAM, a ROM, and first to n-th interfaces for input/output. The display 260 may be a laser projector, or may be a projection apparatus and a projection screen.

In a possible implementation, the controller 250 and the tuning demodulator 210 may be located in separate devices. That is, the tuning demodulator 210 may alternatively be in an external device of a main device where the controller 250 is located, such as an external set-top box.

In a possible implementation, the controller 250 controls operation of the projection display device and responds to user operations through various software control programs stored in the memory. That is, the controller 250 controls an overall operation of the projection display device.

In a possible implementation, a user may enter a user command via a Graphical User Interface (GUI) displayed on the display 260, and the user input interface receives the user input command via the GUI. Alternatively, the user may enter a user command by inputting a specific voice or gesture, and the user input interface receives the user input command by recognizing the voice or gesture via a sensor. In addition, an output interface (such as the display 260 and/or the audio output interface 270) is configured to output user interaction information. The communicator 220 is configured to communicate with a terminal, a server, or other devices.

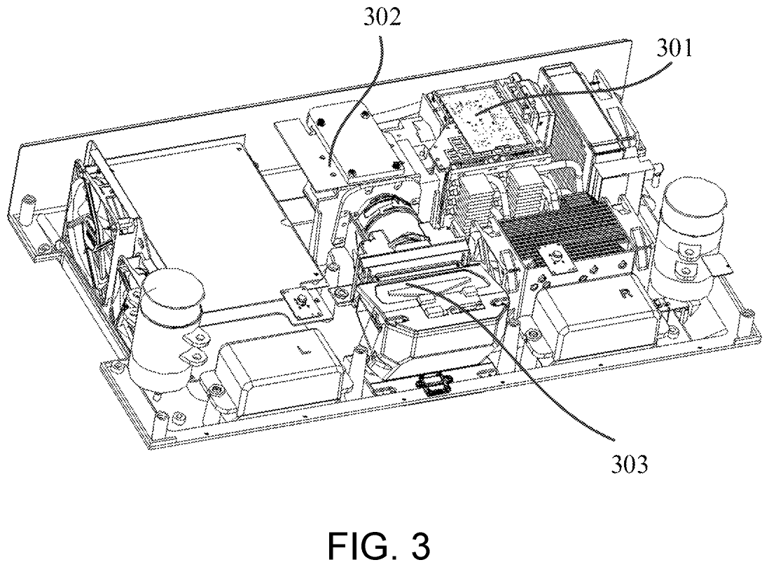

Taking a laser projection device as an example, FIG. 3 is a schematic diagram of an internal structure of a laser projection device according to embodiments of the present application. As shown in FIG. 3, after an upper casing of the laser projection device is removed, an internal structure thereof may be classified, according to optical functions, into: a light source 301, an optical engine 302, and a lens 303. The light source 301 is configured to provide an illumination beam to be transmitted to a downstream optical modulator and the lens 303. The light source 301 may include at least one monochromatic laser of one color, for example, a blue laser. Alternatively, the light source 301 may include a dual-color laser, for example, a blue laser and a red laser. Alternatively, the light source 301 may be a three-color laser light source, that is, it includes lasers of three colors (red, green, and blue) for providing a three-color laser illumination beam.

In a practical application, a laser beam provided by the light source 301 enters an illumination optical path portion of the optical engine 302 after beam combining and shaping. In a Digital Light Processing (DLP) projection architecture, a Digital Micromirror Device (DMD) chip is a core optical modulator. The DMD chip receives a drive control signal corresponding to an image signal, flips thousands of tiny mirrors on a surface thereof at positive or negative angles corresponding to the drive control signal, so as to reflect incident light beam into the lens 303. The lens 303 may be an ultra-short-throw projection lens. The ultra-short-throw projection lens is configured to project an image beam onto the projection screen, thereby achieving display of a projected image.

As an example, the laser projection display device in the above example may be an ultra-short-throw laser projection device.

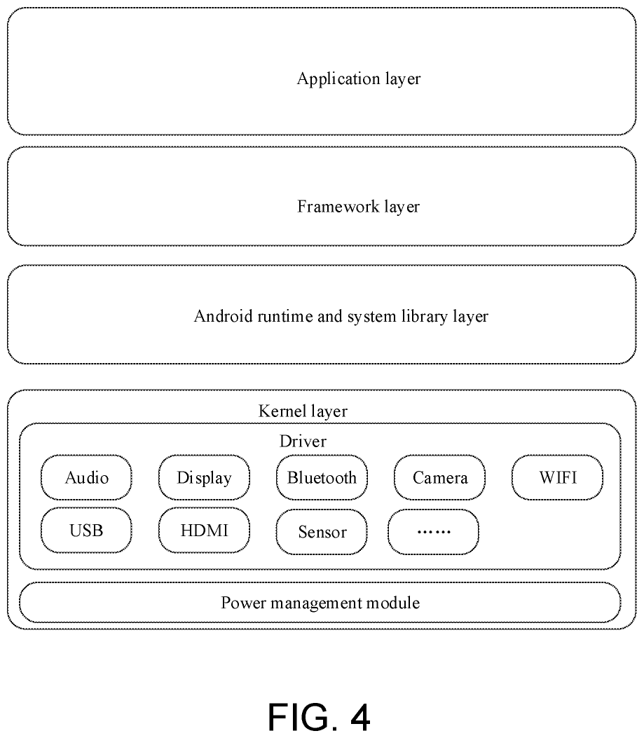

In some embodiments, FIG. 4 is a schematic diagram of software configuration in a projection display device according to embodiments of the present application. As shown in FIG. 4, the system includes four layers, which, from top to bottom, are an Application layer, an Application Framework layer (referred to as a “framework layer”), an Android runtime and system library layer (referred to as a “system runtime library layer”), and a kernel layer.

The kernel layer includes at least one of the following drivers: an audio driver, a display driver, a Bluetooth driver, a camera driver, a Wireless Fidelity (WIFI) driver, a Universal Serial Bus (USB) driver, a High Definition Multimedia Interface (HDMI) driver, a sensor driver (such as a fingerprint sensor, a temperature sensor, or a pressure sensor), a power driver, and the like.

After the structure of the projection display device to which the technical solutions of the embodiments of the present application are applicable is introduced through FIG. 1 to FIG. 4 above, an application scenario of the embodiments of the present application is introduced below.

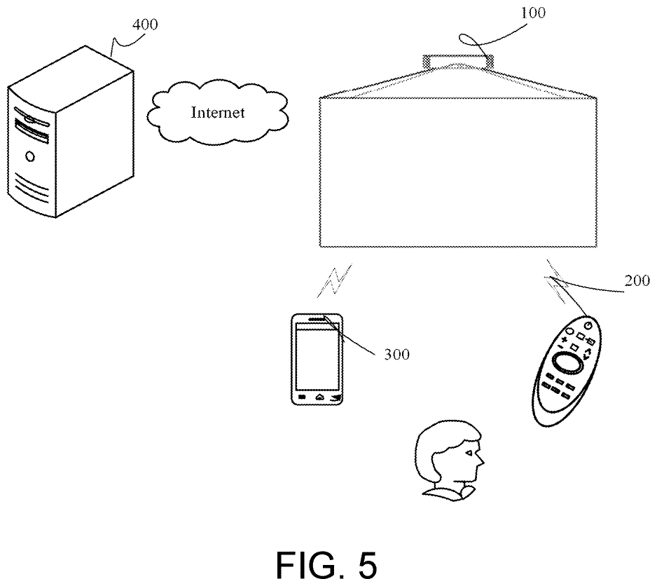

FIG. 5 is a schematic diagram of a scenario in some embodiments according to embodiments of the present application. The application scenario includes a projection display device 100, a control apparatus 200, a smart device 300, and a server 400. The user may control the projection display device 100 via the smart device 300 or the control apparatus 200 to play multimedia resources such as audio and video on the projection display device 100.

The projection display device 100 may have any of the structures in FIG. 1 to FIG. 4 above, which is not limited in the embodiments of the present application.

In a possible implementation, the control apparatus 200 may be a remote control. A communication manner between the remote control and the projection display device 100 includes infrared protocol communication, Bluetooth protocol communication, or the projection display device 100 may be controlled wirelessly or in other wired manners. For example, the user may enter a user instruction via a key on the remote control, voice input, control panel input, or the like, to control the projection display device 100.

In addition, the control apparatus 200 may alternatively be a mobile terminal, a tablet computer, a computer, a notebook computer, or other smart devices for controlling the projection display device 100.

In a possible implementation, the smart device 300 may implement connection and communication with a software application installed in the projection display device 100 via a network communication protocol, so as to implement one-to-one control operations and data communication. In addition, audio and video content displayed on the smart device 300 may be transmitted to the projection display device 100 to implement a synchronous display function.

In a possible implementation, the projection display device 100 further performs data communication with the server 400 via various communication manners. The projection display device 100 may perform communication connections via a Local Area Network (LAN), a Wireless Local Area Network (WLAN), or other networks. The server 400 may provide various content and interaction to the projection display device 100. In addition to providing a broadcast television receiving function, the projection display device 100 may also provide a smart network television function with a computer-supported function.

In a possible implementation, during use, since white balance of the projection display device is easily affected by light source conditions such as a light source, an optical path, and luminous efficacy, color cast may occur during image display, leading to imbalance of white balance. Therefore, there is a need to perform white balance adjustment on the projection display device to ensure that the projection display device can accurately display colors.

To facilitate understanding of the white balance adjustment solution provided in the embodiments of the present application, an optical path architecture, a color gamut chart, a phosphor wheel structure, and color coordinates of the projection display device are first introduced below by taking a laser projection device as an example.

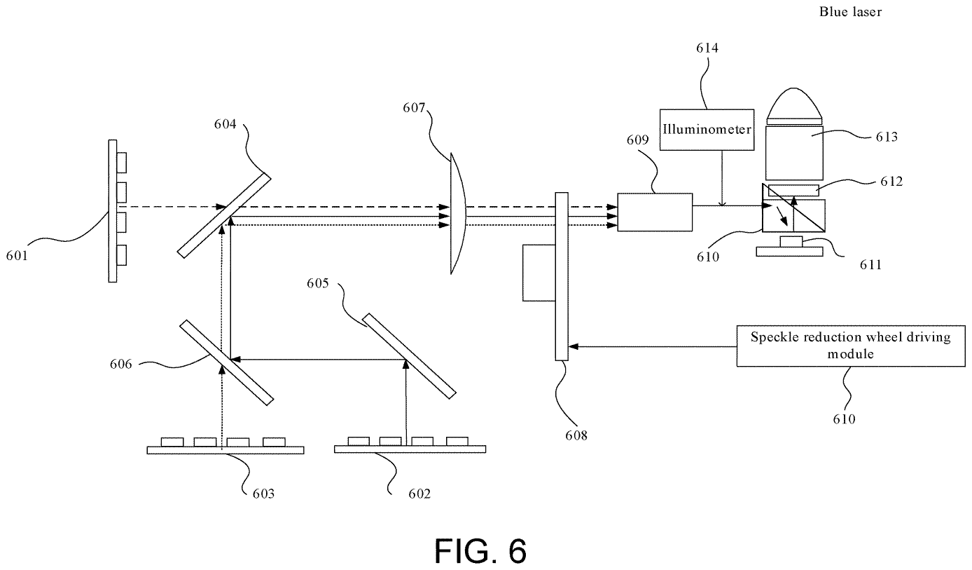

FIG. 6 is a schematic diagram of an optical path architecture of a laser projection device according to embodiments of the present application. The optical path architecture includes: a red laser light source 601, a green laser light source 602, a blue laser light source 603, a first dichroic mirror 604, a reflecting mirror 605, a second dichroic mirror 606, a lens 607, a diffuser wheel 608, a light pipe 609, a total reflection prism 610, a first resolution enhancing device 611, a second resolution enhancing device 612, a projection lens 613, and an illuminometer 614.

It should be noted that the first dichroic mirror 604 can transmit red laser light and reflect green laser light and blue laser light. The reflecting mirror 605 can reflect the green laser light to change an optical path of the green laser light. The second dichroic mirror 606 can reflect the green laser light and transmit the blue laser light. After the red, green, and blue laser light are combined, the combined light enters the diffuser wheel 608. The light is then homogenized by the light pipe 609. The homogenized light enters the total reflection prism 610, passes through the total reflection prism 610, and then enters the first resolution enhancing device 611. Subsequently, the second resolution enhancing device 612 shifts pixel information of the light, and the light is finally projected into the projection lens 613 to project an image.

The illuminometer 614 can detect intensity and coordinates of wavelength optical signals from the red light source, the green light source, and the blue light source.

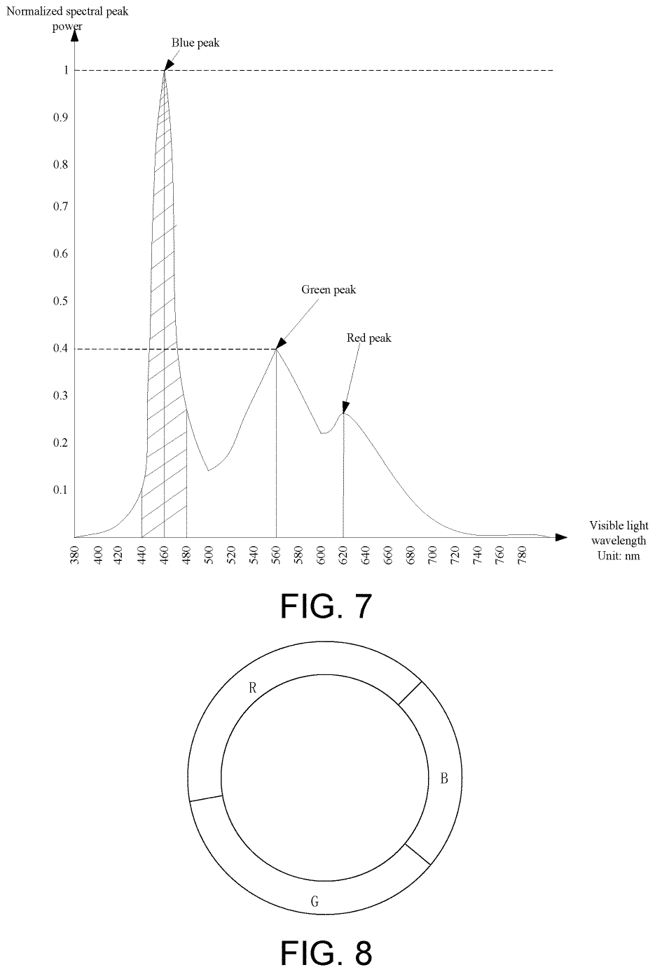

Illustratively, FIG. 7 is a schematic diagram of color coordinate values according to embodiments of the present application. As shown in FIG. 7, spectral peak power of the blue light source, spectral peak power of the green light source, and spectral peak power of the red light source are illustrated.

Exemplarily, FIG. 8 is a schematic structural diagram of a phosphor wheel according to embodiments of the present application, the phosphor wheel may be applied to the laser projection device shown in FIG. 6, and is based on an example in which a laser is a blue laser.

In an annular region of the phosphor wheel, the R region is a red phosphor region, the G region is a green phosphor region, and the B region is a blue laser transmission region. Within one rotation cycle, angles occupied by the regions are different. When the laser is incident on the phosphor wheel, a duration of each primary color light generated by excitation varies. Due to persistence of vision of the human eye, continuously outputted primary color lights (such as red light, green light, and blue light, and may also include yellow light) are perceived by the human eye as white light produced by mixing these primary color lights.

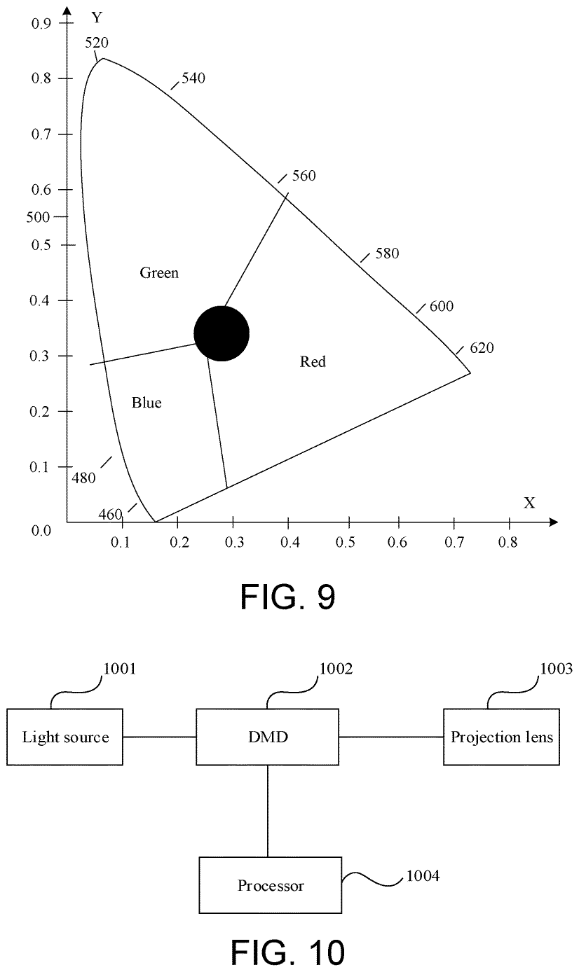

Referring to FIG. 9, FIG. 9 is a schematic diagram of a color gamut chart according to embodiments of the present application. Three regions within a range of a horseshoe shape are respectively red, green, and blue. The green range is located in an upper-left region of the horseshoe shape, and the closer to the edge of this region, the purer the green color. Similarly, the blue range is located in a lower-left region, and the closer to the edge of the lower-left region, the purer the blue color. The red range is located in a lower-right region, and the closer to the edge of the lower-right region, the purer the red color.

When a white balance color coordinate shifts in the color gamut chart, shifting toward a particular region causes the white color to be biased toward that color. The black circular region within the range of the horseshoe shape represents a range of the white balance color coordinates. If the white balance color coordinates exceed this range, the white color exhibits a color cast (imbalance of white balance). If an x-coordinate is excessively large, the white color appears pinkish or yellowish. If the x-coordinate is excessively small, the white color appears bluish. If a y-coordinate is excessively large, the white color appears greenish. If the y-coordinate is excessively small, the white color appears pinkish or purplish.

On this basis, embodiments of the present application provide a projection display device and a white balance adjustment method, so as to monitor and adjust a white light color coordinate of the projection display device to gradually reduce a deviation of color coordinate values, thereby ensuring that the projection display device can always output white light conforming to a desired color standard in different usage environments and conditions.

In order to describe the white balance adjustment method provided in the embodiments of the present application in more detail, a detailed description of a process of performing white balance adjustment on the projection display device provided in the embodiments of the present application will be provided below in conjunction with a specific structure.

It should be understood that the projection display device shown in FIG. 10 described below may alternatively include devices of the structures shown in FIG. 1 to FIG. 6. The embodiments of the present application only use the processor therein as an execution subject to illustrate and explain an implementation process of the white balance adjustment method, which does not constitute a limitation on the specific structure of the projection display device.

Referring to FIG. 10, when performing the white balance adjustment method provided in the embodiments of the present application, the projection display device includes: a primary color light source 1001, a DMD 1002, a projection lens 1003, and a processor 1004.

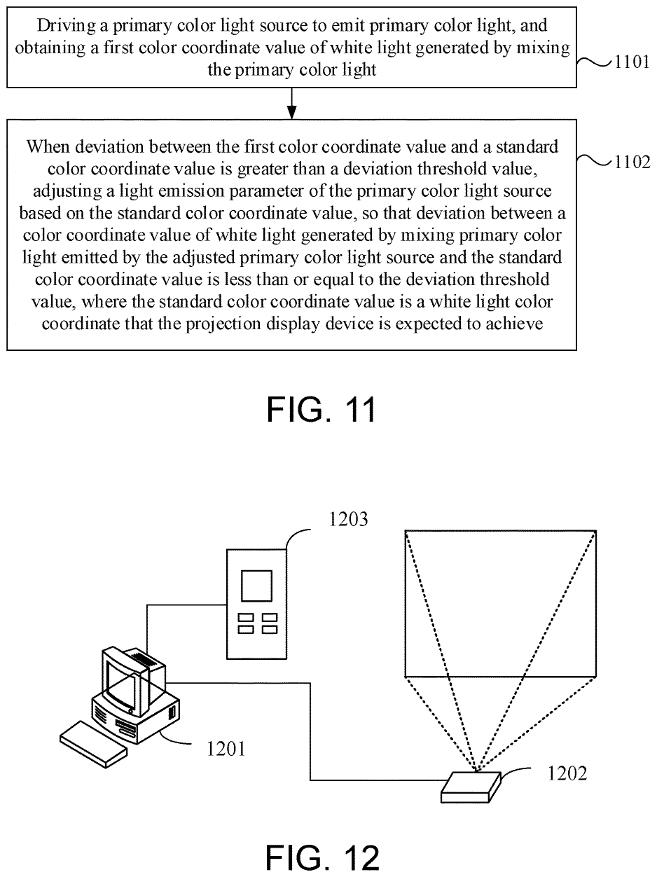

The primary color light source 1001 is configured to emit primary color light. The DMD 1002 is located on a light exit side of the primary color light source, and is configured to modulate the primary color light and reflect the modulated light to the projection lens 1003. The projection lens 1003 is configured to project the light beam exiting from the DMD 1002. The processor 1004 is connected to the DMD 1002, and is configured to perform the white balance adjustment method provided hereinafter in FIG. 11.

As an example, the primary color light source 1001 may be a laser, or may be a Light Emitting Diode (LED) light source, or the like. When the primary color light source 1001 is a laser, it may be a monochromatic laser, a dual-color laser, a three-color laser, or the like, which is not limited in the embodiments of the present application.

A plurality of primary color lights constituting pixel colors are associated with the primary color light source 1001, which may be a light source of three primary colors, namely RGB (Red, Green, Blue), a light source of four primary colors, namely RGBY (Red, Green, Blue, Yellow), or the like. Types of the primary colors are not limited in the present application.

FIG. 11 is a schematic flowchart of a white balance adjustment method according to embodiments of the present application. The method may be applied to the projection display devices shown in FIG. 1 to FIG. 6 and FIG. 10 above. For example, the method is applied to a processor in the projection display device. The method includes the following steps 1101 and 1102.

In step 1101, a primary color light source is driven to emit primary color light, and a first color coordinate value of white light generated by mixing the primary color light is obtained.

In a possible implementation, in the embodiments of the present application, a color sensor is added to the projection display device. As an optical sensor, the color sensor typically operates based on a principle of a photoelectric effect, and can perceive and measure intensity and color characteristics of light. In the projection display device, the color sensor may be disposed at a certain position of a projected image to capture light from the projected image.

In the embodiments of the present application, a color coordinate value of the primary color light emitted by the primary color light source may be collected by the color sensor. In addition, the color sensor may be further configured to collect a brightness value of the primary color light, which is not limited in the embodiments of the present application.

As an example, in the embodiments of the present application, an illuminometer is disposed at a light-transmitting position in an optical engine unit to collect a brightness value and a color coordinate value of the primary color light emitted by the primary color light source, and another illuminometer is disposed at a light-transmitting position on an upper casing of the laser projection device to collect brightness and a color coordinate value of ambient light. Alternatively, an illuminometer that may collect brightness values and color coordinate values of both the primary color light emitted by the primary color light source and the ambient light may be provided.

In a possible implementation, the primary color light source includes a red light source, a green light source, and a blue light source. Correspondingly, the primary color light includes red light emitted by the red light source, green light emitted by the green light source, and blue light emitted by the blue light source.

It should be noted that the first color coordinate value of the white light can reflect a white balance state of the projection display device in a current environmental scenario. However, the white balance of the projection display device is easily affected by factors such as a light source, an optical path, luminous efficacy, and ambient light, leading to color cast during image display and resulting in imbalance of white balance. Therefore, during manufacturing of the projection display device and user operation, there is a need to monitor the white balance state, and perform white balance adjustment in a timely manner in a case of imbalance of white balance, so as to ensure the projection display effect of the projection display device.

It should be understood that, under different light sources (such as daylight, a fluorescent lamp, and an incandescent lamp), a color of an object may vary due to differences in color temperatures of the light sources. For example, under incandescent light, the object may appear yellowish or reddish, whereas under daylight it looks more normal. A white balance technology is used to correct such color deviation caused by differences in the color temperatures of the light sources, thereby making the projected image more realistic and natural.

Considering that the environmental scenario in which the projection display device is located may vary, the implementation for obtaining the first color coordinate value of the white light may vary accordingly under different environmental scenarios (different lighting conditions), which will be described separately below.

In a possible implementation, an implementation process of step 1001 may be: driving the red light source to emit red light to project a red test pattern, and obtaining a color coordinate value of the red light based on the projected red test pattern; driving the green light source to emit green light to project a green test pattern, and obtaining a color coordinate value of the green light based on the projected green test pattern; driving the blue light source to emit blue light to project a blue test pattern, and obtaining a color coordinate value of the blue light based on the projected blue test pattern; and determining the first color coordinate value based on the color coordinate value of the red light, the color coordinate value of the green light, and the color coordinate value of the blue light.

A test pattern is a standardized image configured for testing performance such as a color, brightness, and contrast of the projection display device. The test pattern typically includes a series of specific colors and patterns, such that after being projected by the projection display device, these projected images can be observed and analyzed to evaluate the performance of the projection display device. In addition, the test pattern may be static or dynamic, depending on a test requirement and a type of projection display device.

It should be understood that an RGB color model is based on an additive color mixing principle of the three primary colors, namely red, green, and blue, and different colors can be synthesized by adjusting the three colors. In other words, in the projection display device, the RGB three-primary-color light sources serve as a foundation for generating various colors.

When the projection display device projects the red test pattern, only the red light source is activated, while the green and blue light sources are turned off or in a low-brightness state. In this case, the color sensor may measure the light from the projected image and obtain a color coordinate of the red light. The color coordinate represents a position of the red light source in a chromaticity diagram (e.g., CIE 1931). Similarly, by sequentially projecting the red test pattern, the green test pattern, and the blue test pattern, the color coordinate value of the red light, the color coordinate value of the green light, and the color coordinate value of the blue light may be obtained.

As an example, the color coordinate value of the red light is (xᵣ, yᵣ), the color coordinate value of the green light is (x_{g}, y_{g}), and the color coordinate value of the blue light is (x_{b}, y_{b}).

It should be noted that the projected test pattern generally conforms to a certain standard and specification. By using a standardized test pattern, errors that may occur under different test conditions can be eliminated, thereby improving accuracy of measurement. Therefore, the projected test pattern may serve as a relatively stable test object, reducing influences of these interfering factors, thereby obtaining the color coordinate values of the light source more accurately.

Further, since white light is generated by mixing the red light, the green light, and the blue light, the first color coordinate value of the white light can be determined based on the color coordinate value of the red light, the color coordinate value of the green light, and the color coordinate value of the blue light in a processing manner such as color space conversion

In some embodiments, before the laser projection device leaves the factory, a laser duty cycle is adjusted by using a preset program under a fixed test environment to achieve white balance correction, thereby ensuring a smaller white balance difference between devices. However, after the laser projection device is delivered to the user, the user's usage scenario may differ from the previous test environment in terms of brightness, color temperature, and the like. In addition, long-term use of the laser projection device may also lead to inconsistent laser attenuation rates. If white balance adjustment is still performed according to the preset program, deviation in the white color displayed by the laser projection device may occur, significantly affecting the usage experience of the user.

In other words, in a usage scenario of the user, the projection display device may also be affected by the ambient light, which may cause a shift in the color coordinate value. Therefore, in the white balance adjustment process, when obtaining the first color coordinate value of the white light, an influence of the ambient light needs to be taken into account.

In another possible implementation, an implementation process of step 1001 may be: obtaining a second color coordinate value of ambient light; driving the primary color light source to emit primary color light, and obtaining a third color coordinate value of mixed light, the mixed light referring to light generated by mixing the ambient light and the primary color light; and determining the first color coordinate value according to the second color coordinate value and the third color coordinate value.

The ambient light refers to light in an environment where the projection display device is located, such as natural light, indoor lighting, and the like.

Since a color and brightness of the ambient light may interfere with the color of the projected image and cause a shift in the color coordinate value, when the first color coordinate value of the white light currently projected by the projection display device is detected, by introducing the ambient light, an actual usage scenario is simulated during the correction, thereby improving accuracy and practicality of the correction.

In a possible implementation, an implementation process of determining the first color coordinate value according to the second color coordinate value and the third color coordinate value may be: comparing the second color coordinate value with the third color coordinate value, and establishing a correspondence between a color coordinate value under the mixed light and a color coordinate value under the ambient light, the correspondence representing a degree of influence of the ambient light on the color coordinate value. Based on the correspondence, a degree of interference of the ambient light with the color of the projected image can be predicted, thereby determining the first color coordinate value of the white light.

The correspondence represents an influence of the ambient light on the color coordinate value, which is a non-linear relationship supported by test data.

As an example, Table 1 below shows influences of the ambient light on color coordinate values, illustrating color coordinate values corresponding to different test conditions.

TABLE 1

| | Color coordinate | | | |
|---|---|---|---|---|
| | | | | Luminous |
| Test condition | Standard test pattern | x | y | flux |
| The projection | Red | 0.6285 | 0.3662 | 115.3 |
| display device | Green | 0.3128 | 0.6293 | 552.6 |
| projects a | Blue | 0.1412 | 0.0203 | 34 |
| standard test | White | 0.2916 | 0.322 | 1410 |
| pattern, with the | | | | |
| ambient light | | | | |
| turned off | | | | |
| The projection | | 0.4404 | 0.4087 | 154.6 |
| display device is | | | | |
| screen-off, with | | | | |
| the ambient light | | | | |
| turned on | | | | |
| The projection | Red | 0.4839 | 0.3826 | 339 |
| display device | Green | 0.3492 | 0.5353 | 772.9 |
| projects the | Blue | 0.2078 | 0.1143 | 257 |
| standard test | White | 0.3043 | 0.329 | 1629 |
| pattern, with the | | | | |
| ambient light | | | | |
| turned on | | | | |

As can be seen from Table 1, the first test condition is that the ambient light is turned off and the projection display device projects a primary color test pattern and a white test pattern respectively, the second test condition is that the laser is turned off with only the ambient light present, and the third test condition is that the ambient light is turned on and the projection display device projects a primary color test pattern and a white test pattern respectively. The second test condition serves as a control group. By controlling the variable of the ambient light, it is concluded that the color coordinate value may be affected by the ambient light.

As an example, if the ambient light is yellow light, compared with turning off the ambient light, when the ambient light is turned on, the x-coordinate of the color coordinate value of the white light is larger, the y-coordinate of the color coordinate value of the white light is larger, the x-coordinate of the color coordinate value of the primary color light is smaller, and the y-coordinate of the color coordinate value of the primary color light is larger.

Based on the data shown in Table 1, it is indicated that the ambient light affects the color coordinate value, and when the ambient light is turned on, effects of the ambient light and the projected light on the coordinate value is not a simple addition. It may be understood that the color coordinate value when the ambient light is turned on is not a simple sum of the color coordinate value under the ambient light only and the color coordinate value under the projected light only.

In some embodiments, based on the second color coordinate value A and the third color coordinate value B, a correspondence between the color coordinate value under the mixed light and the color coordinate value under the ambient light is determined as B=f(A). Herein, B denotes color coordinate values of each primary color and the white color under the mixed light, or B denotes brightness values and color coordinate values of each primary color and the white under the mixed light; and A denotes a color coordinate value under the ambient light, or a brightness value and a color coordinate value under the ambient light.

In the above embodiments, through data analysis, the influence of the ambient light on the color coordinate value is determined, and this influence is non-linear. As a result, white balance adjustment does not simply involve reducing the color coordinate value under the ambient light, and therefore step 1102 needs to be performed.

In step 1102, when deviation between the first color coordinate value and a standard color coordinate value is greater than a deviation threshold value, a light emission parameter of the primary color light source is adjusted based on the standard color coordinate value, so that deviation between a color coordinate value of white light generated by mixing primary color light emitted by the adjusted primary color light source and the standard color coordinate value is less than or equal to the deviation threshold value, where the standard color coordinate value is a white light color coordinate that the projection display device is expected to achieve.

The deviation threshold value is a preset threshold value for representing white balance, and is generally set to 0 to determine whether a current coordinate value is consistent with the standard color coordinate value. It should be noted that the user can perceive a change in a color temperature of an image displayed by the laser projection device, such as a warmer or cooler tone. However, due to physiological limitations, the user cannot perceive a change in the color temperature when a difference between two color coordinate values is very small, and thus a certain error is allowed in white balance adjustment. Therefore, the specific value of the deviation threshold value is not limited in the present application.

The standard color coordinate value refers to a coordinate value corresponding to a color on a chromaticity diagram under a specified light source and observation condition. For the projection display device, the standard color coordinate value is typically obtained through precise measurement and calibration at the factory, so as to ensure that the projection display device can present accurate colors in different application scenarios.

As an example, the standard color coordinate value is a white balance index of the projection display device as shipped from the factory delivery. It should be understood that different application scenarios correspond to different standard color coordinate values. A standard color coordinate value corresponding to a target sales region may be determined according to the sales region of the projection display device, or a standard color coordinate value corresponding to a target model may be determined according to a model of the projection display device, or a standard color coordinate value set by the user may be received, which is specifically determined according to an actual requirement and is not limited in the embodiments of the present application. For example, since Europeans are blue-eyed and more sensitive to red stimulation, a proportion of red in the standard color coordinate value set for the laser projection device in a European sales region may be appropriately lower. In contrast, the proportion of red in the standard color coordinate value set for the laser projection device in an Asian sales region may be appropriately higher.

As another example, considering the diversity of usage scenarios of the user and the fact that different application scenarios have different color requirements, the set standard color coordinate values also differ. For example, a home theater scenario typically pursues a natural and comfortable viewing experience, and therefore, the standard color coordinate values are generally set within a range of colors observed by the human eye under natural light. Common standard color coordinate values may include (0.3127, 0.3290) under a D65 light source and the like. These values can ensure that the projected image presents colors close to the real world. A commercial display scenario typically requires the projected image to have vibrant and eye-catching colors to attract the audience's attention, and therefore, the standard color coordinate values may be set within a more saturated and brighter color range. For example, some laser projection devices for commercial display may adopt color coordinate values that are more biased towards red or green, so as to enhance a visual impact of the image. In the field of professional photography/videography, accuracy of colors is extremely demanding, and therefore, the standard color coordinate value may typically be set according to a specific color space (such as sRGB or Adobe RGB), so as to ensure that the projected image can accurately reproduce the colors at the time of shooting. For example, the standard color coordinate value in the sRGB color space may include a red coordinate point such as (0.64, 0.33), a green coordinate point such as (0.15, 0.84), and the like. An educational/conference scenario generally requires the projected image to be clear and legible, and the color to be accurate. Therefore, the standard color coordinate value may typically be set within a range that ensures clarity and color accuracy of content such as text and charts. For example, a color coordinate value close to that of the D65 light source may be used to ensure that the projected image presents natural and clear colors in an environment such as a classroom or conference room.

In a possible implementation, an implementation process of step 1102 may include the following steps.

(1) A target parameter is determined according to the standard color coordinate value.

The target parameter includes a target light emission duration of the primary color light source, and/or target illuminance of the primary color light.

In a possible implementation, the target parameter is calculated through the following formula (1) according to the standard color coordinate value, the color coordinate value of the red light, the color coordinate value of the green light, and the color coordinate value of the blue light:

$$\{ \begin{matrix}( x , y ) = f ( {D}_{r} , {D}_{g} , {D}_{b} , {Y}_{r} , {Y}_{g} , {Y}_{b} ) \\ x = \frac{{C}_{r} {D}_{r} {x}_{r} + {C}_{g} {D}_{g} {x}_{g} + {C}_{b} {D}_{b} {x}_{b}}{{C}_{r} {D}_{r} + {C}_{g} {D}_{g} + {C}_{b} {D}_{b}} \\ y = \frac{{C}_{r} {D}_{r} {y}_{r} + {C}_{g} {D}_{g} {y}_{g} + {C}_{b} {D}_{b} {y}_{b}}{{C}_{r} {D}_{r} + {C}_{g} {D}_{g} + {C}_{b} {D}_{b}}\end{matrix} \qquad ( 1 )$$

In the above formula (1), x denotes a horizontal coordinate of the standard color coordinate value, y denotes a vertical coordinate of the standard color coordinate value, DF denotes a target light emission duration of the red light source, D_{g} denotes a target light emission duration of the green light source, D_{b} denotes a target light emission duration of the blue light source, Yᵣ denotes target illuminance of the red light, Y_{g} denotes target illuminance of the green light, and Y_{b} denotes target illuminance of the red light, xᵣ denotes a horizontal coordinate of the color coordinate value of the red light, x_{g} denotes a horizontal coordinate of the color coordinate value of the green light, x_{b} denotes a horizontal coordinate of the color coordinate value of the blue light, yᵣ denotes a vertical coordinate of the color coordinate value of the red light, y_{g} denotes a vertical coordinate of the color coordinate value of the green light, y_{b} denotes a vertical coordinate of the color coordinate value of the blue light, Cᵣ=Yᵣ/yᵣ, C_{g}=Y_{g}/y_{g}, and C_{b}=Y_{b}/y_{b}.

In the above formula, the standard color coordinate value further satisfies the following formulas:

$$x = \frac{X}{X + Y + Z} = \frac{{C}_{r} {D}_{r} {x}_{r} + {C}_{g} {D}_{g} {x}_{g} + {C}_{b} {D}_{b} {x}_{b}}{{C}_{r} {D}_{r} + {C}_{g} {D}_{g} + {C}_{b} {D}_{b}} \qquad ( 2 )$$

$$y = \frac{Y}{X + Y + Z} = \frac{{C}_{r} {D}_{r} {y}_{r} + {C}_{g} {D}_{g} {y}_{g} + {C}_{b} {D}_{b} {y}_{b}}{{C}_{r} {D}_{r} + {C}_{g} {D}_{g} + {C}_{b} {D}_{b}} \qquad ( 3 )$$

$${D}_{r} + {D}_{g} + {D}_{b} = 100 \% \qquad ( 4 )$$

where X, Y, and Z denote coordinates in a color space, and x, y, and z denote coordinates in a planar coordinate system.

Based on the above formulas, according to Grassmann's laws of color mixture, it may be known that:

$${Y}_{m} = {Y}_{r} + {Y}_{g} + {Y}_{b} = {D}_{r} {Y}_{r} + {D}_{g} {Y}_{g} + {D}_{b} {Y}_{b} \qquad ( 5 )$$

Yₘ denotes luminous flux of a mixture of red light, green light, and blue light. The where greater the current supplied to each primary color light source, the greater the corresponding values of Yᵣ, Y_{g}, and Y_{b}.

Based on the above formula, it can be known that the first color coordinate value obtained by the projection display device is related to a lighting duration of the primary color light source and illuminance of the primary color light. Therefore, in the embodiments of the present application, when deviation between the first color coordinate value of the white light and the standard color coordinate value is greater than the deviation threshold value, the first color coordinate value can be adjusted by adjusting the target parameter, i.e., a target light emission duration of the primary color light source and/or target illuminance of the primary color light, such that deviation between a color coordinate value of the white light generated by mixing the primary color light emitted by the adjusted primary color light source and the standard color coordinate value is less than or equal to the deviation threshold value.

(2) The light emission parameter of the primary color light source is adjusted according to the target parameter, so that the deviation between the color coordinate value of the white light generated by mixing the primary color light emitted by the adjusted primary color light source and the standard color coordinate value is less than or equal to the deviation threshold value.

In a possible implementation, an initial light emission duration of the primary color light source is adjusted to the target light emission duration, and/or initial illuminance of the primary color light is adjusted to the target illuminance, so that deviation between a coordinate value of the white light generated by mixing the primary color light emitted by the adjusted primary color light source and the standard color coordinate value is less than or equal to the deviation threshold value.

It should be noted that after each adjustment, the color coordinate value of the white light is required to be obtained again to determine whether the adjusted color coordinate value is less than the deviation threshold value. When a color coordinate value of the white light generated by mixing the primary color light emitted by the primary color light source is greater than the deviation threshold value, the above adjustment process is repeated until deviation between the adjusted color coordinate value of the white light and the standard color coordinate value is less than the deviation threshold value, thereby enabling the projection display device to project an image without color cast according to the adjusted color coordinate value, ensuring a white balance effect.

In some embodiments, after the target parameter is determined, a correspondence between the first color coordinate value and the target parameter may further be stored in the projection display device.

In this way, when the projection device determines that the color coordinate value of the white light generated by mixing the primary color light emitted by the primary color light source is the first color coordinate value, the light emission parameter of the primary color light source may be adjusted according to the target parameter to ensure the white balance effect.

In summary, in the embodiments of the present application, when it is detected that deviation between the first color coordinate value and a preset standard color coordinate value is greater than the deviation threshold value, the white balance adjustment procedure is started. Based on the standard color coordinate value, the processor may adjust the light emission parameter of the primary color light source, so as to gradually reduce the deviation of the color coordinate values. Through this auto-correction mechanism, the projection display device can ensure that white light conforming to a desired color standard is always outputted in different usage environments and conditions. Thus, by means of accurate color control and correction, color distortion and deviation of the projection display device can be reduced, enhancing the definition and contrast of images, thereby enhancing the display stability and consistency.

After white balance adjustment is performed on the projection display device, a current duty cycle of the primary color light source in the projection display device may change. Generally, the current duty cycle has a linear relationship with a current value The larger the current duty cycle, the larger the corresponding current value. Therefore, when the current duty cycle changes, a brightness value of the primary color light emitted by the primary color light source in the projection display device may also change. In this case, an image (especially a grayscale image) projected by the projection display device may exhibit color cast, and brightness of the image observed by the user's eye may also decrease, affecting user experience.

Taking a laser projection display device as an example, the following relationship exists for the laser projection display device:

$${L}_{1} = {L}_{laser} \times {( \frac{{L}_{pixel}}{1023} )}^{λ} \qquad ( 6 )$$

where L₁ denotes brightness of the laser projection display device as perceived by the human eye, which may be represented by luminous flux, Lₗₐₛₑᵣ denotes brightness of the primary color light source in the projection display device, which is also represented by luminous flux, Lₚᵢₓₑₗ denotes pixel brightness, which is represented by a pixel grayscale value, and λ denotes a parameter preset in the projection display device, which may have a value of 2.2.

As can be known from the above formula (6), the brightness of the laser projection display device as perceived by the human eye is related not only to the brightness of the laser light source, but also to the pixel brightness.

As an example, for primary color light source (R, G, B) components in a projection display device with a 10-bit color depth, the pixel brightness Lₚᵢₓₑₗ ranges from 0 to 1023.

Taking a monochromatic laser projection device as an example, after white balance adjustment is performed on the monochromatic laser projection device, brightness Lₗₐₛₑᵣ of its laser light source may be adjusted. In this case, if an original pixel brightness Lₚᵢₓₑₗ value of a video signal is still used, a displayed image may exhibit distortion in display brightness and color, and color cast may occur during playback of grayscale image content. For example, when a 32-grayscale image is displayed, reddish color cast appears at some grayscales, such as at grayscales 12 and 13.

On this basis, to ensure that a display effect of an image projected by the projection display device after white balance adjustment remains unchanged, there is a need to compensate for, according to the adjusted brightness of the primary color light source, pixels of a target image to be displayed, so as to make up for an influence caused by reduction in brightness of the primary color light source.

For the projection display device, the following relationship also exists:

$${L}_{2} = {KU}^{λ} \qquad ( 7 )$$

where L₂ denotes actual output brightness of the projection display device, which may be represented by luminous flux, U denotes an input video signal of the projection display device, and λ denotes a parameter preset in the projection display device.

As can be seen, for the projection display device, there is an exponential relationship, rather than a linear relationship, between the actual output brightness L₂ thereof and the input video signal U.

Regarding image pixel compensation, a principle thereof may be explained through the following formulas (8) to (16).

First, the following formulas (8) to (9) may be derived according to the above formula (6)

$${L}_{typical} = {L}_{laser - typical} \times {( \frac{{L}_{pixel - typical}}{1023} )}^{λ} \qquad ( 8 )$$

$${L}_{reduce} = {L}_{laser - reduce} \times {( \frac{{L}_{pixel - reduce}}{1023} )}^{λ} \qquad ( 9 )$$

In the above formula (8), “typical” represents respective parameter values before white balance adjustment (i.e., before adjustment of the brightness of the primary color light source, referred to as “before dimming”). For example, L_{typical} denotes brightness of the projection display device as perceived by the human eye before dimming, which may be represented by luminous flux. L_{laser-typical} denotes output brightness of the primary color light source before dimming, L_{pixel-typical} denotes pixel brightness before dimming, and λ denotes a parameter preset in the projection display device.

In the above formula (9), “reduce” represents respective parameter values after white balance adjustment (i.e., after adjustment of the brightness of the primary color light source, referred to as “after dimming”). For example, L_{reduce} denotes brightness of the projection display device as perceived by the human eye after dimming, which may be represented by luminous flux. L_{laser-reduce} denotes output brightness of the primary color light source after dimming, L_{pixel-reduce} denotes pixel brightness after dimming, and λ denotes a parameter preset in the projection display device.

Generally, the output brightness of the primary color light source after dimming is lower than the output brightness of the primary color light source before dimming. Therefore, if it is desired to keep brightness of the projection display device as perceived by the human eye before dimming and after dimming unchanged, there is a need to increase the pixel brightness. That is, the pixel brightness after dimming is required to be compensated for to ensure that the brightness of the image observed by the human eye does not change significantly and that there is no color cast during display of a multi-grayscale image.

Further, if it is desired to keep the brightness of the projection display device as perceived by the human eye before and after white balance adjustment (i.e., before and after dimming) unchanged, based on the above formulas (8) and (9), there is a need to satisfy the following formula (10):

$${L}_{typical} = {L}_{reduce} \qquad ( 10 )$$

That is, the following formula (11) is required to be satisfied:

$${L}_{laser - typical} \times {( \frac{{L}_{pixel - typical}}{1023} )}^{λ} = {L}_{laser - reduce} \times {( \frac{{L}_{pixel - reduce}}{1023} )}^{λ} \qquad ( 11 )$$

For convenience of explanation, a proportional value k is introduced herein, and k satisfies the following formula (12):

$$k = \frac{{L}_{laser - typical}}{{L}_{laser - reduce}} = {( \frac{{L}_{pixel - reduce}}{{L}_{pixel - typical}} )}^{λ} \qquad ( 12 )$$

The following formulas (13) to (14) may be further derived based on the formula (12):

$${L}_{laser - reduce} = \frac{1}{K} {L}_{laser - typical} \qquad ( 13 )$$

$$\frac{{L}_{pixel - reduce}}{{L}_{pixel - typical}} = {k}^{\frac{1}{λ}} \qquad ( 14 )$$

Further, a parameter k′ is introduced, and k′ satisfies the following formula (15):

$${k}^{′} = {{k}^{\frac{1}{λ}} ( \frac{{L}_{laser - typical}}{{L}_{laser - reduce}} )}^{\frac{1}{λ}} \qquad ( 15 )$$

$${L}_{pixel - reduce} = {k}^{\frac{1}{λ}} \times {L}_{pixel - typical} = {k}^{′} \times {L}_{pixel - typical} \qquad ( 16 )$$

As can be known from the above formulas (8) to (16), after white balance adjustment, when the brightness of the primary color light source is reduced to 1/k of that before dimming, the pixel brightness may be compensated by multiplying the pixel grayscale value of the video image before dimming by the parameter k′, thereby avoiding the color cast while ensuring that the brightness of the projection display device as perceived by the human eye remains the same before and after dimming.

In summary, after white balance adjustment is performed on the projection display device, the brightness of the primary color light may change. In this case, in order to prevent the problem of color cast caused by the projection display device invoking a preset basic pixel grayscale value and also to prevent the problem of reduced brightness of the projection display device as perceived by the human eye before and after white balance adjustment, there is a need to calibrate the basic pixel grayscale value.

It should be noted that a plurality of sets of current duty cycles corresponding to the primary color light sources as well as a set of pixel grayscale values may typically be preset in the projection display device. When white balance adjustment is performed, the preset current duty cycles and pixel grayscale values may be directly invoked to control the DMD to display the image. However, when the current duty cycle after white balance adjustment deviates from the preset plurality of sets of current duty cycles and the preset pixel grayscale values are still used, color cast may occur in some grayscales of the image.

On this basis, embodiments of the present application further provide a white balance adjustment method, so that after white balance adjustment is performed on the projection display device, a processor receives target current duty cycles corresponding to a plurality of primary color light sources constituting pixel colors and sent by a main control device. If the target current duty cycle does not match a basic current duty cycle, a target pixel grayscale value corresponding to the target current duty cycle is determined, so as to control the DMD to display a target image based on the target current duty cycle and the target pixel grayscale value. In this way, the problem of color cast caused by directly invoking pre-stored basic pixel grayscale values corresponding to the basic current duty cycles in the projection display device can be prevented, and the problem of reduced brightness of the projection display device as perceived by the human eye is also prevented.

Referring to FIG. 12, which is a schematic architectural diagram of a white balance adjustment system according to embodiments of the present application, a main control device 1201 is connected to a projection display device 1202 and an illuminometer 1203 respectively.

In the embodiments of the present application, the main control device 1201 controls the projection display device 1202 to enter a white balance adjustment mode, and the projection display device 1202 sequentially projects a plurality of frames of test images (which may also be the standard test patterns as described above, i.e., the red test pattern, the green test pattern, and the blue test pattern). The illuminometer 1203 is configured to detect color coordinate values and brightness values of the plurality of frames of test images when the projection display device 1201 sequentially projects the plurality of frames of test images. The plurality of frames of test images are in different colors, such as a red test image, a yellow test image, and a blue test image.

The main control device 1201 determines, based on the color coordinate values and the brightness values of the test images detected by the illuminometer 1203, target current duty cycles corresponding to different primary color light sources of the projection display device 1202 when the primary color light sources achieve preferred white balance under a current projection environment.

As an example, the main control device may be a personal computer (PC), a tablet computer, a smartphone, or another terminal with data computing and processing capabilities.

Further, after determining the target current duty cycle, the main control device 1201 may send the target current duty cycle to the projection display device 1202.

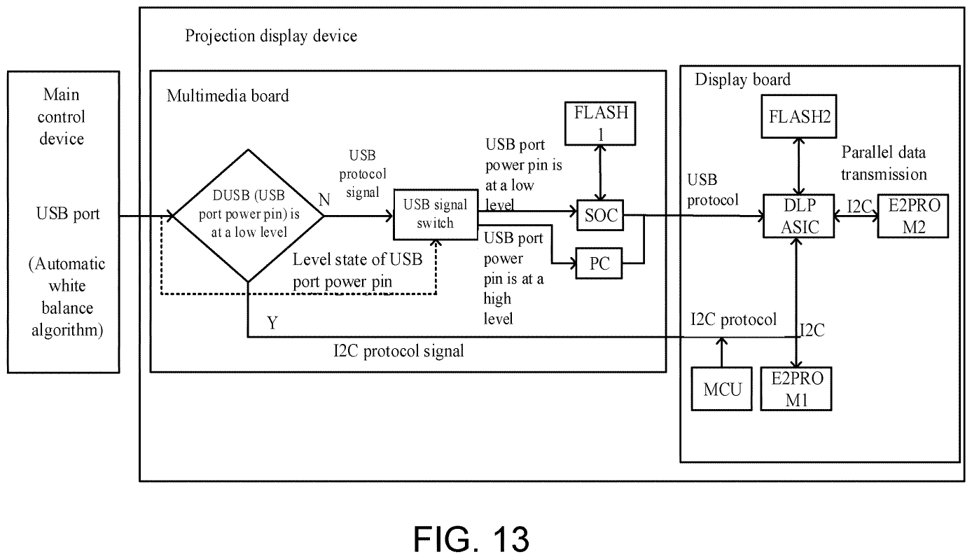

Referring to FIG. 13, which is a schematic structural diagram of hardware of a main control device and a projection display device according to embodiments of the present application, the main control device runs a white balance algorithm and may communicate with the projection display device via a USB port.

In a possible implementation, the projection display device includes a multimedia board and a display board. The multimedia board may include a USB signal switch, a System on Chip (SoC), and a flash memory device FLASH1.

The display board may include a plurality of devices such as a Digital Light Processing Application Specific Integrated Circuit (DLP ASIC), a flash memory FLASH2, a memory E2PROM1, a Micro Control Unit (MCU), and a memory E2PROM2.

The DLP ASIC communicates with the flash memory FLASH2 by parallel data transmission, communicates with the E2PROM2 and the E2PROM1 via an I2C protocol, and communicates with the SoC via a USB protocol.

In a possible implementation, the multimedia board may communicate with the main control device via the USB port. When white balance adjustment is performed on the projection display device, the main control device may transmit data to the E2PROM2 corresponding to the MCU for storage via the I2C protocol. The E2PROM2 stores current data sets corresponding to the respective primary color light sources for white balance, including information such as current duty cycles and current values.

In a possible implementation, alternatively, based on the USB protocol, the SoC or the PC is controlled by the USB signal switch to transmit data to the DLP ASIC, so that the DLP ASIC executes a corresponding instruction. If a power pin of the USB port is at a high level, data transmission may be performed via the SoC. If the power pin of the USB port is at a low level, data transmission may be performed via the PC.

The above is merely an exemplary hardware architecture, and the hardware architecture of the projection display device and the main control device are not limited in the embodiments of the present application.

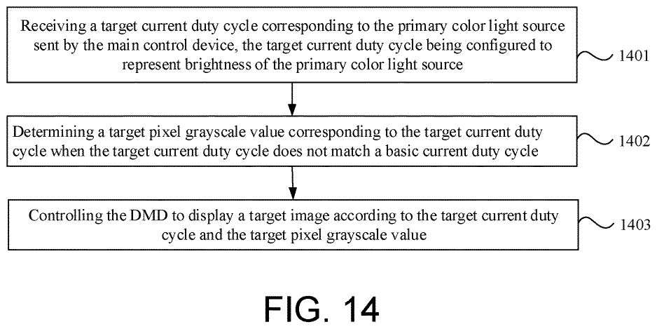

Referring to FIG. 14, which is a schematic flowchart of another white balance adjustment method according to embodiments of the present application, the method may compensate for the pixel brightness after the white balance adjustment shown in FIG. 11 described above is performed on the projection display device. Similarly, the method may also be applied to the projection display devices shown in FIG. 1 to FIG. 6, FIG. 10, FIG. 12, and FIG. 13 above and, for example, applied to a processor in the projection display device. The method includes the following steps 1401 to 1403.

In step 1401, a target current duty cycle corresponding to the primary color light source sent by the main control device is received, the target current duty cycle being configured to represent brightness of the primary color light source.

It should be noted that the current duty cycle may represent magnitude of a current value. The current value has a linear relationship with the current duty cycle, and the larger the current duty cycle, the larger the current value. The current is a driving current configured to control the primary color light source to emit light. When the driving current corresponding to a primary color light source is larger, the brightness of the corresponding primary color light source is higher. Therefore, after white balance is performed on the projection display device, the main control device may determine the target current duty cycle corresponding to the primary color light source based on a current environmental scenario. The target current duty cycle changes compared to the current duty cycles of the projection display device before white balance adjustment, that is, the brightness of the primary color light source of the projection display device is controlled to change.

A set of current duty cycles includes current duty cycles respectively corresponding to a plurality of primary color light sources. For example, the target current duty cycle includes a target current duty cycle corresponding to the red light source, a target current duty cycle corresponding to the green light source, and a target current duty cycle corresponding to the blue light source.

In step 1402, when the target current duty cycle does not match a basic current duty cycle, a target pixel grayscale value corresponding to the target current duty cycle is determined.

Similarly, the basic current duty cycle includes a basic current duty cycle corresponding to the red light source, a basic current duty cycle corresponding to the green light source, and a basic current duty cycle corresponding to the blue light source.

In a possible implementation, it is determined that the target current duty cycle matches the basic current duty cycle when the target current duty cycle of each primary color light source included in the target current duty cycle is the same as the basic current duty cycle of the corresponding primary color light source in the basic current duty cycle, or a difference between the target current duty cycle and the basic current duty cycle of the corresponding primary color light source is within an error range.

As an example, current duty cycles corresponding to the RGB primary colors included in the target current duty cycle are A0, B0, and C0, respectively. The basic current duty cycle includes n sets of data. Current duty cycles corresponding to RGB primary colors included in a first set of basic current duty cycles are A1, B1, and C1, respectively, current duty cycles corresponding to RGB primary colors included in a second set of basic current duty cycles are A2, B2, and C2, respectively, and current duty cycles corresponding to RGB primary colors included in an nth set of basic current duty cycles are An, Bn, and Cn, respectively.

It is determined that the target current duty cycle matches the second set of basic current duty cycles when A0=A2, B0=B2, and C0=C2.

Alternatively, it may also be determined that the target current duty cycles match the first set of basic current duty cycles when the current duty cycles A0, B0, and C0 corresponding to the RGB primary colors included in the target current duty cycle are all different from the current duty cycles corresponding to the RGB primary colors included in the n sets of basic current duty cycles, but a difference between A0 and A1 is less than a first preset range, a difference between B0 and B1 is less than a second preset range, and a difference between C0 and C1 is less than a third preset range.

The first preset range, the second preset range, and the third preset range may be the same or different, and may be set according to an actual requirement, which are not limited in the embodiments of the present application.

In some embodiments, in addition to the preset basic current duty cycles, a set of basic pixel grayscale values is also stored in the projection display device. When the target current duty cycle matches one set of basic current duty cycles, there is no need to determine a target pixel grayscale value, and the preset basic pixel grayscale values may be directly used for image display.

In another possible implementation, it is determined that the target current duty cycle does not match the basic current duty cycle when the target current duty cycle of any primary color light source included in the target current duty cycle is different from the current duty cycle of the corresponding primary color light source in the basic current duty cycle, or a difference between the target current duty cycle and the current duty cycle of the corresponding primary color light source is not within an error range.

As an example, it is determined that the target current duty cycle does not match the n sets of basic current duty cycles when A0, B0, and C0 in the target current duty cycle are all different from An, Bn, and Cn in the n sets of basic current duty cycles, i.e., A0≠An, B0≠Bn, and C0≠Cn, or when only the current duty cycle corresponding to one primary color is different from the corresponding basic current duty cycle, i.e., A0=An, B0=Bn, and C0/Cn.

It may be determined that the target current duty cycle does not match the plurality of sets of basic current duty cycles when a difference between a current duty cycle of any primary color in the target current duty cycle and a current duty cycle of the corresponding primary color in the basic current duty cycle is not within a preset range, for example, if A0=An, B0=Bn, and C0≠Cn, and the difference between C0 and Cn is not within the preset range, i.e., exceeds the preset range.

Further, when the target current duty cycle does not match the basic current duty cycle, in order to prevent the problem of color cast and the problem of low image brightness, there is a need to compensate for the pixel brightness. In this case, there is a need to determine a target pixel grayscale value after compensation based on the target current duty cycle.

In a possible implementation, an implementation process of step 1402 may include: receiving pixel correction information sent by the main control device, the pixel correction information including a brightness value of the primary color light source, a frame rate of an input signal corresponding to each primary color light, and a grayscale of the input signal; and determining a target pixel grayscale value corresponding to the target current duty cycle according to the pixel correction information.

Taking the RGB primary colors as an example for illustration, when the basic pixel grayscale values are calibrated to determine the target pixel grayscale value, bitplane time accumulation (i.e., display time determination) may be performed based on a brightness value of an illumination light beam outputted by a light source 401, a frame rate of a red input signal, and a grayscale of the red input signal, so as to perform image output.

As an example, the grayscale of the red input signal may be divided into m bitplanes, and corresponding m bitplane test patterns may be displayed respectively. Brightness (i.e., a grayscale value) of each bitplane test pattern is determined, thereby determining a target pixel grayscale value corresponding to the primary color, i.e., red.

Further, a display time for each bitplane test pattern may be determined based on a weight of each bitplane, so as to display the image based on the display time. Reference may be made to Table 2, which represents a correspondence between bitplanes and display times.

TABLE 2

| bitplane | Display time (μs) | Weight |
|---|---|---|
| 0 | T | 1 |
| 1 | 2 T | 2 |
| 2 | 4 T | 4 |
| 3 | 8 T | 8 |
| 4 | 16 T | 16 |
| . . . | . . . | . . . |
| m-1 | 2^{m-1}T | 2^{m-1} |

Similarly, green and blue calibration may be performed sequentially. Since a white image is composed of red, green, and blue images, after completion of calibration of red, green, and blue, it may indicate that the white image is successfully calibrated.

In step 1403, the DMD is controlled to display a target image according to the target current duty cycle and the target pixel grayscale value.

In some embodiments, after determining the target current duty cycle, the projection display device may further take the target current duty cycle as the basic current duty cycle, and store a correspondence between the target current duty cycle and the target pixel grayscale value.

In this way, when it is detected during subsequent use that the current duty cycle of the primary color light source is the target current duty cycle, the target pixel grayscale value may be directly obtained without recalculation.

In some embodiments, the projection device may alternatively receive a target current value sent by the main control device, the target current value indicating that an image mode of the projection display device is a white balance mode; and store a correspondence between the target current value and the target current duty cycle.

In this way, when it is detected during subsequent use that the current value of the primary color light source is the target current value, the target pixel grayscale value may be directly acquired without recalculation.

As an example, the correspondence between the target current value and the target current duty cycle may be stored in a first memory, and the correspondence between the target current duty cycle and the target pixel grayscale value may be stored in a second memory. The first memory and the second memory may be Electrically-Erasable Programmable Read-Only Memories (E2PROMs), or may be other memories, which are not limited in the present application.

In some embodiments, after the target current value and the target current duty cycle are stored in the second memory, when white balance adjustment is performed on the projection display device again, the main control device generates a new set of target current duty cycles, and the new target current duty cycles are denoted as first target current duty cycles. After receiving the first target current duty cycles, the projection display device may match the first target current duty cycles with the preset plurality of sets of basic current duty cycles and the target current duty cycle stored in the second memory. If the first target current duty cycles match one set of target current duty cycles in the second memory, the target current duty cycle and the target pixel grayscale value corresponding to the target current duty cycle may be directly invoked, without repeatedly calculating target pixel grayscale values corresponding to the first target current duty cycles.

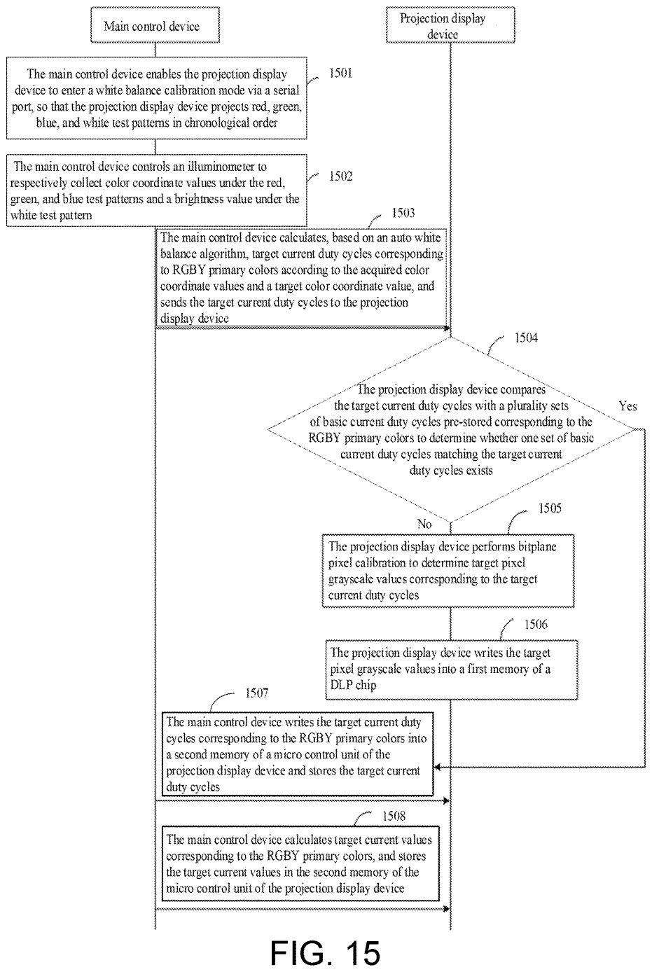

To facilitate understanding, FIG. 15 provides a schematic flowchart of yet another white balance adjustment method according to embodiments of the present application. As shown in FIG. 15, an interaction process between the main control device and the projection display device when white balance adjustment is performed is as follows:

In S1501, the main control device enables the projection display device to enter a white balance calibration mode via a serial port, so that the projection display device projects red, green, blue, and white test patterns in chronological order.

The red, green, blue, and white test patterns are test images.

In an implementation scenario, before white balance adjustment is performed, the projection display device may be powered on first, so as to start up the projection display device. For example, the projection display device may be powered on by supplying AC 220 V power.

In S1502, the main control device controls an illuminometer to respectively collect color coordinate values of the red, green, and blue test patterns and a brightness value of the white test pattern.

In S1503, the main control device calculates, based on an auto white balance algorithm, target current duty cycles corresponding to RGBY primary colors according to the obtained color coordinate values and a target color coordinate value, and sends the target current duty cycles to the projection display device.

In S1504, the projection display device compares the target current duty cycles with a plurality sets of basic current duty cycles pre-stored corresponding to the RGBY primary colors, to determine whether one set of basic current duty cycles matching the target current duty cycles exists. If not, steps S1505 to S1508 are performed. If yes, steps S1507 to S1508 are performed.

In S1505, the projection display device performs bitplane pixel calibration to determine target pixel grayscale values corresponding to the target current duty cycles.

In S1506, the projection display device writes the target pixel grayscale values into a first memory of a DLP chip.

In S1507, the main control device writes the target current duty cycles corresponding to the RGBY primary colors into a second memory of a micro control unit of the projection display device and stores the target current duty cycles.

In S1508, the main control device calculates target current values corresponding to the RGBY primary colors, and stores the target current values in the second memory of the micro control unit of the projection display device.

The target current value and the target current duty cycle correspond to an auto white balance image mode in a user interface (UI) of a multimedia unit.

During the white balance adjustment, the processing process of the main control device and the processing process of the projection display device can be obtained with reference to the foregoing embodiments, and the principles thereof are substantially the same. Details are not described herein again in the present application.

In summary, in the embodiments of the present application, after white balance adjustment is performed on the projection display device, when it is determined that the target current duty cycle does not match the preset plurality of sets of basic current duty cycles, the preset basic pixel grayscale values are not directly invoked for image display. Instead, the target pixel grayscale value corresponding to the target current duty cycle is determined, thereby preventing the problem of color cast in image grayscales before and after white balance adjustment is performed on the projection display device, and also ensuring that the brightness of the projection display device as perceived by the human eye remains the same before and after white balance adjustment is performed on the projection display device.

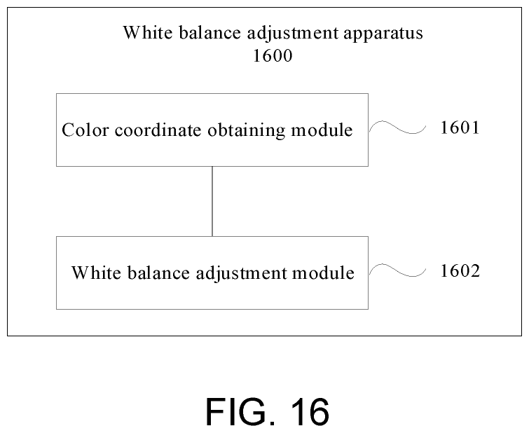

FIG. 16 is a schematic structural diagram of a white balance adjustment apparatus according to embodiments of the present application. The white balance adjustment apparatus may be included in the projection display device provided in the embodiments of the present application. As shown in FIG. 16, the white balance adjustment apparatus 1600 includes:

a color coordinate obtaining module 1601 configured to drive a primary color light source to emit primary color light, and obtain a first color coordinate value of white light generated by mixing the primary color light; and

a white balance adjustment module 1602 configured to adjust a light emission parameter of the primary color light source based on the standard color coordinate value when deviation between the first color coordinate value and a standard color coordinate value is greater than a deviation threshold value, so that deviation between a color coordinate value of white light generated by mixing primary color light emitted by the adjusted primary color light source and the standard color coordinate value is less than or equal to the deviation threshold value, wherein the standard color coordinate value is a white light color coordinate that the projection display device is expected to achieve.

In a possible implementation, the primary color light source includes a red light source, a green light source, and a blue light source; the primary color light includes red light emitted by the red light source, green light emitted by the green light source, and blue light emitted by the blue light source; and the color coordinate obtaining module 1601 is specifically configured to:
drive the red light source to emit red light to project a red test pattern, and obtain a color coordinate value of the red light based on the projected red test pattern;
drive the green light source to emit green light to project a green test pattern, and obtain a color coordinate value of the green light based on the projected green test pattern;
drive the blue light source to emit blue light to project a blue test pattern, and obtain a color coordinate value of the blue light based on the projected blue test pattern; and
determine the first color coordinate value based on the color coordinate value of the red light, the color coordinate value of the green light, and the color coordinate value of the blue light.

In a possible implementation, the white balance adjustment module 1602 is specifically configured to:
determine a target parameter according to the standard color coordinate value; and
adjust the light emission parameter of the primary color light source according to the target parameter, so that the deviation between the color coordinate value of the white light generated by mixing the primary color light emitted by the adjusted primary color light source and the standard color coordinate value is less than or equal to the deviation threshold value.

In a possible implementation, the target parameter includes a target light emission duration of the primary color light source, and/or target illuminance of the primary color light; the primary color light source includes a red light source, a green light source, and a blue light source; the primary color light includes red light emitted by the red light source, green light emitted by the green light source, and blue light emitted by the blue light source; and the white balance adjustment module 1602 is specifically configured to:
calculate the target parameter through the following formula according to the standard color coordinate value, the color coordinate value of the red light, the color coordinate value of the green light, and the color coordinate value of the blue light;

$$\{ \begin{matrix}( x , y ) = f ( {D}_{r} , {D}_{g} , {D}_{b} , {Y}_{r} , {Y}_{g} , {Y}_{b} ) \\ x = \frac{{C}_{r} {D}_{r} {x}_{r} + {C}_{g} {D}_{g} {x}_{g} + {C}_{b} {D}_{b} {x}_{b}}{{C}_{r} {D}_{r} + {C}_{g} {D}_{g} + {C}_{b} {D}_{b}} \\ y = \frac{{C}_{r} {D}_{r} {y}_{r} + {C}_{g} {D}_{g} {y}_{g} + {C}_{b} {D}_{b} {y}_{b}}{{C}_{r} {D}_{r} + {C}_{g} {D}_{g} + {C}_{b} {D}_{b}}\end{matrix}$$

where x denotes a horizontal coordinate of the standard color coordinate value, y denotes a vertical coordinate of the standard color coordinate value, Dᵣ denotes a target light emission duration of the red light source, D_{g} denotes a target light emission duration of the green light source, D_{b} denotes a target light emission duration of the blue light source, Yᵣ denotes target illuminance of the red light, Y_{g} denotes target illuminance of the green light, and Y_{b} denotes Y target illuminance of the red light; xᵣ denotes a horizontal coordinate of the color coordinate value of the red light, x_{g} denotes a horizontal coordinate of the color coordinate value of the green light, x_{b} denotes a horizontal coordinate of the color coordinate value of the blue light, yᵣ denotes a vertical coordinate of the color coordinate value of the red light, y_{g} denotes a vertical coordinate of the color coordinate value of the green light, y_{b} denotes a vertical coordinate of the color coordinate value of the blue light, Cᵣ=Yᵣ/yᵣ, C_{g}=Y_{g}/Y_{g}, and C_{b}=Y_{b}/y_{b}.

In a possible implementation, the white balance adjustment module 1602 is specifically configured to:
adjust an initial light emission duration of the primary color light source to the target light emission duration, and/or adjust initial illuminance of the primary color light to the target illuminance, so that deviation between a coordinate value of the white light generated by mixing the primary color light emitted by the adjusted primary color light source and the standard color coordinate value is less than or equal to the deviation threshold value.

In a possible implementation, the white balance adjustment module 1600 is further configured to:
store a correspondence between the first color coordinate value and the target parameter.

In a possible implementation, the color coordinate acquisition module 1601 is specifically configured to:
obtain a second color coordinate value of ambient light;
drive the primary color light source to emit primary color light, and obtain a third color coordinate value of mixed light, the mixed light referring to light generated by mixing the ambient light and the primary color light; and
determine the first color coordinate value according to the second color coordinate value and the third color coordinate value.

In a possible implementation, the white balance adjustment module 1600 is further configured to:
receive a target current duty cycle corresponding to the primary color light source sent by the main control device, the target current duty cycle being configured to represent brightness of the primary color light source;
determine a target pixel grayscale value corresponding to the target current duty cycle when the target current duty cycle does not match a basic current duty cycle; and
control the DMD to display a target image according to the target current duty cycle and the target pixel grayscale value.

In a possible implementation, the white balance adjustment module 1600 is further configured to:
receive pixel correction information sent by the main control device, the pixel correction information comprising a brightness value of the primary color light source, a frame rate of an input signal corresponding to each primary color light, and a grayscale of the input signal; and
determine a target pixel grayscale value corresponding to the target current duty cycle according to the pixel correction information.

In a possible implementation, the white balance adjustment module 1600 is further configured to:
determine that the target current duty cycle matches the basic current duty cycle when a target current duty cycle of each primary color light source comprised in the target current duty cycle is the same as a basic current duty cycle of the corresponding primary color light source in the basic current duty cycle, or a difference between the target current duty cycle and the basic current duty cycle of the corresponding primary color light source is within an error range.

In a possible implementation, the white balance adjustment module 1600 is further configured to:
determine that the target current duty cycle does not match the basic current duty cycle when a target current duty cycle of any primary color light source comprised in the target current duty cycle is not the same as a current duty cycle of the corresponding primary color light source in the basic current duty cycle, or a difference between the target current duty cycle and the current duty cycle of the corresponding primary color light source is not within an error range.

In a possible implementation, the white balance adjustment module 1600 is further configured to:
take the target current duty cycle as the basic current duty cycle, and store a correspondence between the target current duty cycle and the target pixel grayscale value.

In a possible implementation, the white balance adjustment module 1600 is further configured to:
receive a target current value sent by the main control device, the target current value indicating that an image mode of the projection display device is a white balance mode; and
store a correspondence between the target current value and the target current duty cycle.

In summary, in the embodiments of the present application, a current state of a color coordinate of white light is monitored and fed back by a processor, and when it is detected that deviation between a first color coordinate value and a preset standard color coordinate value is greater than a deviation threshold value, a white balance adjustment procedure is started. Based on the standard color coordinate value, the processor may adjust light emission parameters of the primary color light source, so as to gradually reduce the deviation of the color coordinate values. Through this auto-correction mechanism, the projection display device can always output white light conforming to desired color standards in different usage environments and conditions. Thus, by means of accurate color control and correction, color distortion and deviation of the projection display device are reduced, the definition and contrast of images are improved, thereby enhancing the display stability and consistency. In addition, since the device can automatically adapt to environmental changes and adjust color parameters, a user does not need to manually perform complex color settings and adjustments, thereby simplifying an operation process and improving convenience of use. Moreover, by automatically adjusting the light emission parameters, aging of or damage to the light source caused by prolonged operation in a non-standard color state can be avoided, which also helps to prolong the service life of the projection display device to some extent.

It should be noted that when performing white balance adjustment on the projection display device, the white balance adjustment apparatus provided in the above embodiments is illustrated only by way of example by using the division of the above functional modules. In practical applications, the above functions may be allocated to different functional modules as required, that is, the internal structure of the apparatus may be divided into different functional modules to accomplish all or some of the functions described above. In addition, the white balance adjustment device provided in the above embodiments belongs to the same inventive concept as the white balance adjustment method embodiments shown in FIG. 11 and FIG. 14 described above. For the specific implementation process thereof, reference may be made to the method embodiments, and details are not described herein again.

Embodiments of the present application further provide a computer-readable storage medium. The computer-readable storage medium has a computer program stored therein. When the computer program is executed by a processor, the processor is caused to implement the white balance method described in the embodiments of the present application. Specific implementations and technical effects are the same, which are not described in detail herein again.

The computer-readable storage medium may include a USB flash drive, a removable hard disk, a ROM, a RAM, a CD-ROM, a magnetic tape, a floppy disk, an optical data storage device, and the like. The computer-readable storage medium may alternatively be a non-volatile storage medium, which, in other words, may be a non-transitory storage medium.

It should be understood that all or some of the steps of implementing the above embodiments may be implemented by software, hardware, firmware, or any combination thereof. When implemented using software, the steps may be implemented in whole or in part as a computer program product. The computer program product includes one or more computer instructions. The computer instructions may be stored in the above computer-readable storage medium.

That is, embodiments of the present application further provide a computer program product. When the computer program product is run on a computer, the computer is caused to implement the white balance method described in the embodiments of the present application. Specific implementations and technical effects are the same, which are not described in detail herein again.

Finally, it should be noted that the above embodiments are merely intended to describe the technical solutions of the present application, but not to limit the present application. Although the present application is described in detail with reference to the foregoing embodiments, those of ordinary skill in the art should understand that they may still make modifications to the technical solutions described in the foregoing embodiments or make equivalent replacements to some technical features thereof. Such modifications or replacements do not cause the essence of the corresponding technical solutions to depart from the spirit and scope of the technical solutions of the embodiments of the present application.

The above descriptions are embodiments provided in the present application and are not intended to limit the present application. Any modifications, equivalent substitutions, improvements, and the like made within the spirit and principles of the present application should be included within the protection scope of the present application.

1. A projection display device, wherein the projection display device comprises:
a primary color light source configured to emit primary color light;
a digital micromirror device (DMD) located on a light exit side of the primary color light source and configured to modulate the primary color light and reflect the modulated light to a projection lens;
the projection lens being configured to project a light beam exiting from the DMD; and
a processor connected to the primary color light source and configured to:
drive the primary color light source to emit primary color light, and obtain a first color coordinate value of white light generated by mixing the primary color light; and
when deviation between the first color coordinate value and a standard color coordinate value is greater than a deviation threshold value, adjust a light emission parameter of the primary color light source based on the standard color coordinate value, so that deviation between a color coordinate value of white light generated by mixing primary color light emitted by the adjusted primary color light source and the standard color coordinate value is less than or equal to the deviation threshold value, wherein the standard color coordinate value is a white light color coordinate that the projection display device is expected to achieve.

2. The projection display device according to claim 1, wherein the primary color light source comprises a red light source, a green light source, and a blue light source; the primary color light comprises red light emitted by the red light source, green light emitted by the green light source, and blue light emitted by the blue light source; and the processor is specifically configured to:
drive the red light source to emit red light to project a red test pattern, and obtain a color coordinate value of the red light based on the projected red test pattern;
drive the green light source to emit green light to project a green test pattern, and obtain a color coordinate value of the green light based on the projected green test pattern;
drive the blue light source to emit blue light to project a blue test pattern, and obtain a color coordinate value of the blue light based on the projected blue test pattern; and
determine the first color coordinate value based on the color coordinate value of the red light, the color coordinate value of the green light, and the color coordinate value of the blue light.

3. The projection display device according to claim 1, wherein the processor is specifically configured to:
determine a target parameter according to the standard color coordinate value; and
adjust the light emission parameter of the primary color light source according to the target parameter, so that the deviation between the color coordinate value of the white light generated by mixing the primary color light emitted by the adjusted primary color light source and the standard color coordinate value is less than or equal to the deviation threshold value.

4. The projection display device according to claim 3, wherein the target parameter comprises a target light emission duration of the primary color light source, and/or target illuminance of the primary color light.

5. The projection display device according to claim 4, wherein the primary color light source comprises a red light source, a green light source, and a blue light source; the primary color light comprises red light emitted by the red light source, green light emitted by the green light source, and blue light emitted by the blue light source; and the processor is specifically configured to:
calculate the target parameter through the following formula according to the standard color coordinate value, the color coordinate value of the red light, the color coordinate value of the green light, and the color coordinate value of the blue light;
$$\{ \begin{matrix}( x , y ) = f ( {D}_{r} , {D}_{g} , {D}_{b} , {Y}_{r} , {Y}_{g} , {Y}_{b} ) \\ x = \frac{{C}_{r} {D}_{r} {x}_{r} + {C}_{g} {D}_{g} {x}_{g} + {C}_{b} {D}_{b} {x}_{b}}{{C}_{r} {D}_{r} + {C}_{g} {D}_{g} + {C}_{b} {D}_{b}} \\ y = \frac{{C}_{r} {D}_{r} {y}_{r} + {C}_{g} {D}_{g} {y}_{g} + {C}_{b} {D}_{b} {y}_{b}}{{C}_{r} {D}_{r} + {C}_{g} {D}_{g} + {C}_{b} {D}_{b}}\end{matrix}$$
wherein x denotes a horizontal coordinate of the standard color coordinate value, y denotes a vertical coordinate of the standard color coordinate value, Dᵣ denotes a target light emission duration of the red light source, D_{g} denotes a target light emission duration of the green light source, D_{b} denotes a target light emission duration of the blue light source, Yᵣ denotes target illuminance of the red light, Y_{g} denotes target illuminance of the green light, and Y_{b} denotes target illuminance of the red light; xᵣ denotes a horizontal coordinate of the color coordinate value of the red light, xᵣ denotes a horizontal coordinate of the color coordinate value of the green light, x_{b} denotes a horizontal coordinate of the color coordinate value of the blue light, yᵣ denotes a vertical coordinate of the color coordinate value of the red light, y_{g} denotes a vertical coordinate of the color coordinate value of the green light, y_{b} denotes a vertical coordinate of the color coordinate value of the blue light, Cᵣ=Yᵣ|yᵣ, C_{g}=Y_{g}|y_{g}, and C_{b}=Y_{b}/y_{b}.

6. The projection display device according to claim 4, wherein the processor is specifically configured to:
adjust an initial light emission duration of the primary color light source to the target light emission duration, and/or adjust initial illuminance of the primary color light to the target illuminance, so that deviation between a coordinate value of the white light generated by mixing the primary color light emitted by the adjusted primary color light source and the standard color coordinate value is less than or equal to the deviation threshold value.

7. The projection display device according to claim 3, wherein the processor is further configured to:
store a correspondence between the first color coordinate value and the target parameter.

8. The projection display device according to claim 1, wherein the processor is specifically configured to:
obtain a second color coordinate value of ambient light;
drive the primary color light source to emit primary color light, and obtain a third color coordinate value of mixed light, the mixed light referring to light generated by mixing the ambient light and the primary color light; and
determine the first color coordinate value according to the second color coordinate value and the third color coordinate value.

9. The projection display device according to claim 1, wherein the projection display device is connected to a main control device; and after adjusting the light emission parameters of the primary color light source, so that the deviation between the color coordinate value of the white light generated by mixing the primary color light emitted by the adjusted primary color light source and the standard color coordinate value is less than or equal to the deviation threshold value, the processor is further configured to:
receive a target current duty cycle corresponding to the primary color light source sent by the main control device, the target current duty cycle being configured to represent brightness of the primary color light source;
determine a target pixel grayscale value corresponding to the target current duty cycle when the target current duty cycle does not match a basic current duty cycle; and
control the DMD to display a target image according to the target current duty cycle and the target pixel grayscale value.

10. The projection display device according to claim 9, wherein the processor is specifically configured to:
receive pixel correction information sent by the main control device, the pixel correction information comprising a brightness value of the primary color light source, a frame rate of an input signal corresponding to each primary color light, and a grayscale of the input signal; and
determine a target pixel grayscale value corresponding to the target current duty cycle according to the pixel correction information.

11. The projection display device according to claim 9, wherein the processor is further configured to:
determine that the target current duty cycle matches the basic current duty cycle when a target current duty cycle of each primary color light source comprised in the target current duty cycle is the same as a basic current duty cycle of the corresponding primary color light source in the basic current duty cycle, or a difference between the target current duty cycle and the basic current duty cycle of the corresponding primary color light source is within an error range.

12. The projection display device according to claim 9, wherein the processor is specifically configured to:
determine that the target current duty cycle does not match the basic current duty cycle when a target current duty cycle of any primary color light source comprised in the target current duty cycle is not the same as a current duty cycle of the corresponding primary color light source in the basic current duty cycle, or a difference between the target current duty cycle and the current duty cycle of the corresponding primary color light source is not within an error range.

13. The projection display device according to claim 9, wherein the processor is further configured to:
take the target current duty cycle as the basic current duty cycle, and store a correspondence between the target current duty cycle and the target pixel grayscale value.

14. The projection display device according to claim 9, wherein the processor is further configured to:
receive a target current value sent by the main control device, the target current value indicating that an image mode of the projection display device is a white balance mode; and
store a correspondence between the target current value and the target current duty cycle.

15. A white balance adjustment method, applied to a projection display device, the method comprising:
driving a primary color light source to emit primary color light, and obtaining a first color coordinate value of white light generated by mixing the primary color light; and
adjusting a light emission parameter of the primary color light source based on the standard color coordinate value when deviation between the first color coordinate value and a standard color coordinate value is greater than a deviation threshold value, so that deviation between a color coordinate value of white light generated by mixing primary color light emitted by the adjusted primary color light source and the standard color coordinate value is less than or equal to the deviation threshold value, wherein the standard color coordinate value is a white light color coordinate that the projection display device is expected to achieve.

16. The white balance adjustment method according to claim 15, wherein the method further comprises:
determining a target parameter according to the standard color coordinate value; and
adjusting the light emission parameter of the primary color light source according to the target parameter, so that the deviation between the color coordinate value of the white light generated by mixing the primary color light emitted by the adjusted primary color light source and the standard color coordinate value is less than or equal to the deviation threshold value;
wherein the target parameter comprises a target light emission duration of the primary color light source, and/or target illuminance of the primary color light.

17. The white balance adjustment method according to claim 15, wherein the method further comprises:
obtain a second color coordinate value of ambient light;
drive the primary color light source to emit primary color light, and obtain a third color coordinate value of mixed light, the mixed light referring to light generated by mixing the ambient light and the primary color light; and
determine the first color coordinate value according to the second color coordinate value and the third color coordinate value.

18. The white balance adjustment method according to claim 15, wherein after adjusting the light emission parameters of the primary color light source, so that the deviation between the color coordinate value of the white light generated by mixing the primary color light emitted by the adjusted primary color light source and the standard color coordinate value is less than or equal to the deviation threshold value, the method further comprises:
determining a target pixel grayscale value corresponding to the target current duty cycle when the target current duty cycle does not match a basic current duty cycle; and
controlling the DMD to display a target image according to the target current duty cycle and the target pixel grayscale value.

19. A white balance adjustment system, wherein the system comprises: a main control device, an illuminometer, and the projection display device according to claim 9, the main control device being connected to the projection display device and the illuminometer respectively; and
the main control device being configured to control the projection display device to enter a white balance calibration mode, so that the projection display devices project a plurality of test images in chronological order; and control the illuminometer to collect color coordinate values corresponding to the test images, determine, according to a white balance algorithm and the color coordinate values, target current duty cycles corresponding to a plurality of primary colors constituting pixel colors, and send the target current duty cycles to the projection display device.

20. A non-transitory computer-readable storage medium, wherein the non-transitory computer-readable storage medium has a computer program stored therein, when the computer program is executed by a processor, the method according to claim 15 being implemented.
